(19) United States
(12) Patent Application Publication
(10) Pub. No.: US 2026/0228434 A1
(43) Pub. Date: Aug. 6, 2026

(54) Leveraging Generative Artificial Intelligence To Automatically Derive Playbooks and Automations From A Collection Of Records

(71) Applicant: ServiceNow, Inc., Santa Clara, CA (US)

(72) Inventors: Krishnadeep Puchalapalli, Bengaluru (IN); Yaron Lehmann, Sunnyvale, CA (US); Ramkumar Devanathan, Bangalore (IN); Laxman Rao Tallury, Bengaluru (IN); Chandrasekhar Thotakura, Nellore (IN); Robert Bitterfeld, Petah Tikva (IL); Akshay Narayan Hargude, Pune (IN); Pavan Kondapuram Sreenivasa, Salem (IN)

(21) Appl. No.: 19/042,069

(22) Filed: Jan. 31, 2025

(51) Int. Cl. G06F 40/30; G06F 16/34

(52) U.S. Cl. CPC G06F 40/30; G06F 16/345

(57) ABSTRACT

Embodiments of the subject technology relate to systems, methods, and computer-readable media for automatically generating a playbook. Specifically, incidents having resolutions can be clustered together through an embedding model based on a similarity criterion. A summary of each of the incidents can be generated through an LLM. A playbook for resolving an incident can be inferred through the LLM based on the summaries of the incidents.

### BACKGROUND

### 1. Technical Field

The present disclosure generally relates to playbook development, and more specifically to inferring a playbook through a large language model (LLM).

### 2. Introduction

In modern information technology (IT) environments, incidents such as system failures, and service disruptions are frequently encountered. Organizations often maintain large volumes of closed incident records, which contain valuable resolution knowledge. However, manually creating a playbook from these incidents is time-consuming and error prone. Additionally, incident records are not uniform across different entities. Such discrepancies in incident records makes it difficult to create a playbook from the incidents across the different entities.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for automatically generating a playbook for resolving an incident through an LLM, according to some examples of the present disclosure;

FIG. 3 illustrates a flowchart of an example method of clustering incidents and generating a playbook for resolving an incident through an LLM based on summaries of the clustered incidents, according to some examples of the present disclosure;

FIG. 4 illustrates a flowchart of an example method of prefiltering incidents to cluster incidents and filtering, prioritizing, and selecting the clustered incidents in generating a playbook for resolving an incident, according to some examples of the present disclosure;

FIG. 5 illustrates a flowchart of an example method of re-clustering incidents and generating a playbook based on the re-clustered incidents, according to some examples of the present disclosure;

FIG. 6 is an example of a deep learning neural network that can be used to implement all or a portion of the systems and techniques described herein, according to some examples of the present disclosure;

FIG. 7 is a diagram illustrating an example architecture of an example transformer model, according to some examples of the present disclosure; and

FIG. 8 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

In modern IT environments, incidents such as system failures, and service disruptions are frequently encountered. Organizations often maintain large volumes of closed incident records, which contain valuable resolution knowledge. However, manually creating a playbook from these incidents is time-consuming and error prone. Manual solutions can also rely on input and predefined templates, which can fail to account for the vast amounts of historical data regarding incidents that can be maintained by organizations. Additionally, incident records are not uniform across different entities. Such discrepancies in incident records makes it difficult to create a playbook from the incidents across the different entities.

The disclosed technology addresses the foregoing by clustering incidents with resolutions together for forming a playbook. The clustering can be done in an automated matter, thereby eliminating any need for a human to check large volumes of closed incident records. Further, the clustering can be done through an embedding model which can account for discrepancies in incident records across different entities.

The disclosed technology also addresses the foregoing by generating a summary comprising a description of the steps for achieving the resolution in each of the incidents through a large language model (LLM). As follows, the summaries of the incidents can be used by the LLM to infer a playbook based on the incidents. For example, the LLM can be iteratively prompted with the different resolution steps in the summaries of the incidents to infer a playbook for resolving an incident. Using an LLM to create the summary and the playbook can eliminate or minimize the amount of human effort that is expended in generating the playbook. Further, by using an LLM to create the incident summaries and the playbook, discrepancies in incident records across different entities can be accounted for in creating the summaries and the playbook. As follows, the ability to use resolved incidents across different entities increases data diversity, leading to the creation of a playbook that is more accurate and efficient in resolving a specific incident.

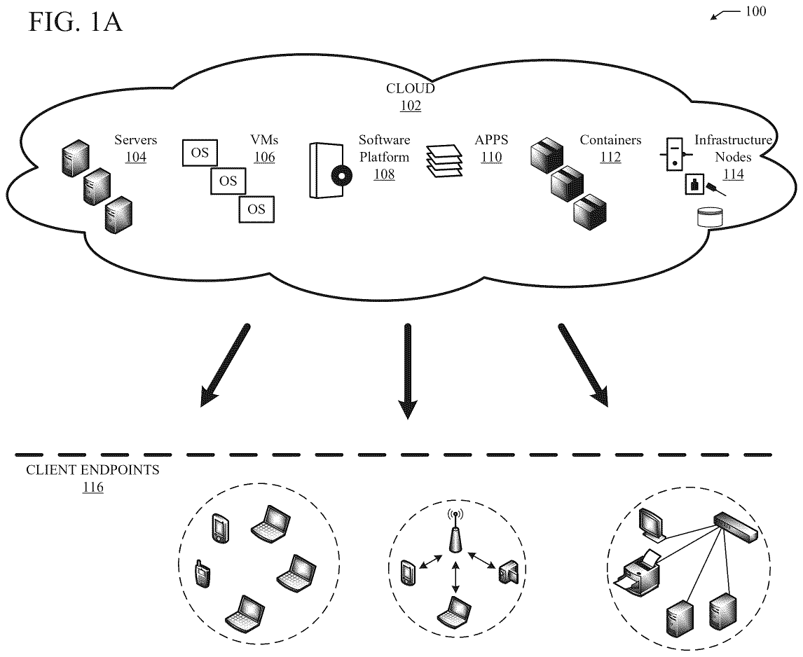

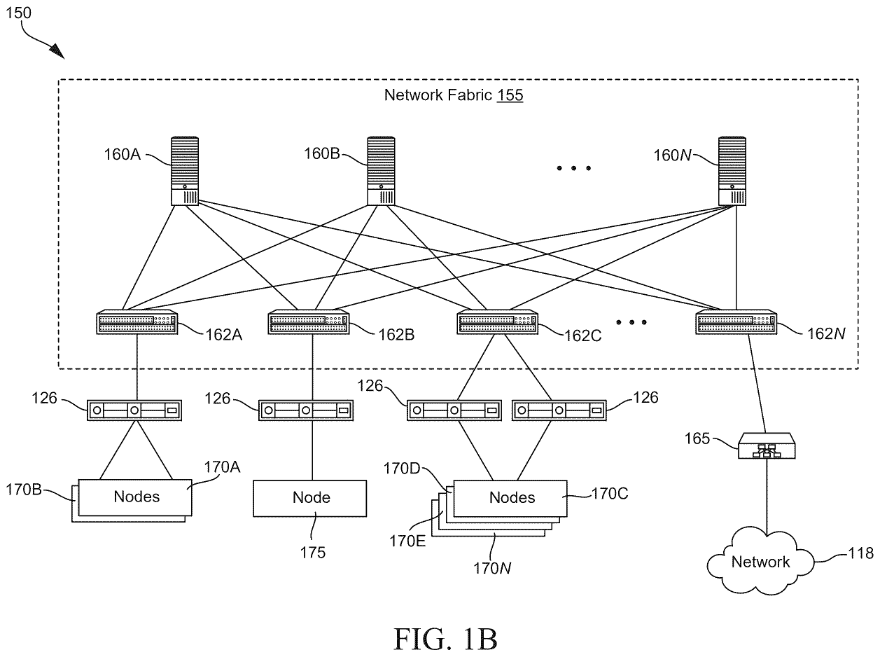

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

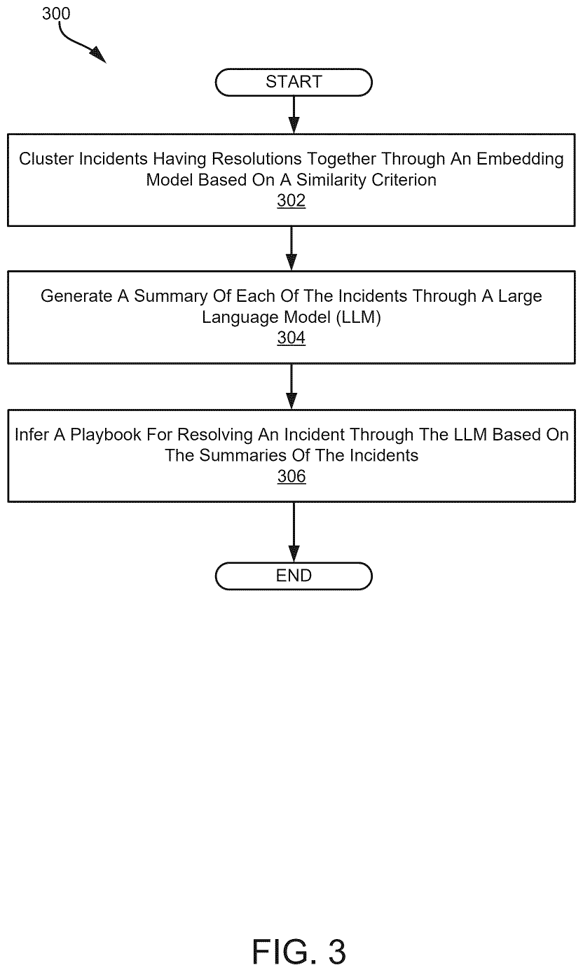

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, machine learning (ML) models and large language models (LLMs) and other applicable models and applications can be implemented through the architectures 100 and 150.

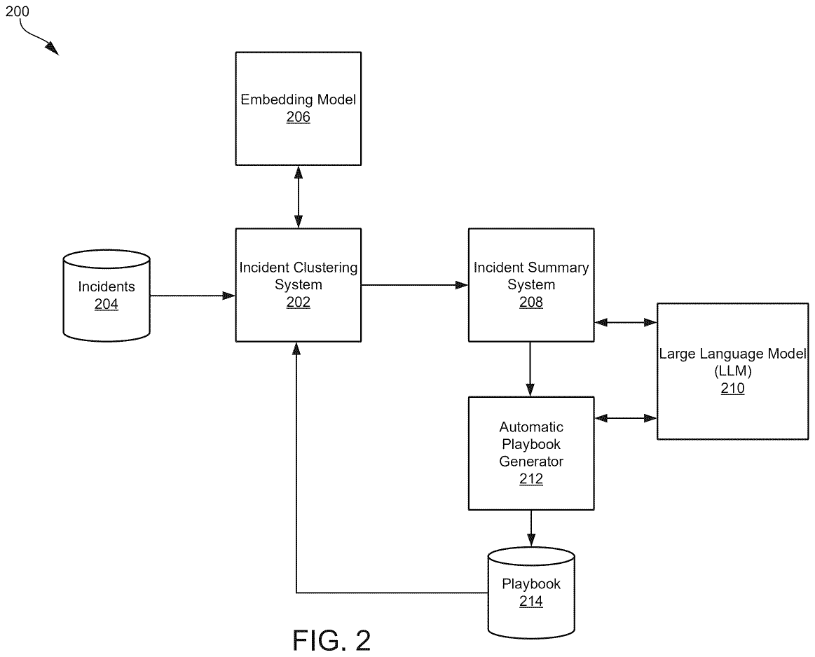

FIG. 2 illustrates a schematic diagram of an architecture 200 for automatically generating a playbook for resolving an incident through an LLM. The architecture comprises an incident clustering system 202 and an incidents datastore 204. The incidents datastore 204 stores incident data describing historical incidents that have occurred. Specifically, an incident, as used herein, can comprise an event that disrupts normal operations and can potentially be resolved through a playbook. Specifically, an incident can comprise an IT incident, a legal operation incident, or other application events that disrupt normal operation within an organization.

Incidents can have varying occurrence rates. An incident can be a unique incident with a low chance of occurring again. For example, an incident can be a unique attack launched against an enterprise. Alternatively, an incident can be a frequently occurring incident. For example, an incident can be a routine problem associated with accessing an email account. An incident can either have a resolution or not have a resolution. A resolution to an incident, as used herein, can include fixing a disruption, e.g. to a service or infrastructure, as part of the incident. A resolution to an incident, as used herein, can also include achieving a state in response to a disruption that is acceptable to a controlling authority. For example, a resolution to an incident can be that the disruption has been eliminated and any effects caused by the disruption have been remedied.

A playbook, as used herein, can comprise a series of stages to follow in achieving a resolution for an incident. The stages can be related and followed in a specific sequence in achieving the resolution for the incident. Specifically, the stages can be organized in a hierarchical, e.g. tree structure. More specifically, the stages can form one or more branches in the hierarchical structure that can be traversed in attempting to resolve an incident according to the playbook. For example, a playbook can comprise a stage for identifying a cause of an incident, a stage for containing the cause of the incident, and a stage for remedying changes caused by the incident. In another example, a playbook can comprise a stage of interacting with a customer to identify an IT issue and a stage of remedying the IT issue. In various embodiments, a playbook can correspond to an incident or a type of incident. For example a playbook can comprise steps for resolving a specific IT issue. In another example, a playbook can comprise steps for resolving a broad category of IT issues that are all the same type of IT incident.

A hierarchical structure of a playbook can comprise different trigger-specific actions and corresponding trigger points that guide completion of the actions. Specifically, each stage in the hierarchical structure can comprise different trigger-specific actions and corresponding triggers that cause performance of one or more of the trigger-specific actions in completing the stage of the playbook. The trigger-specific actions can form different sections, e.g. branches, in the hierarchical structure and trigger points can guide which sections, corresponding to the trigger-specific actions, to perform in traversing the hierarchical structure. For example, the hierarchical structure of a playbook for resolving a denial-of-service attack can include actions that are performed in series to identify the resources that are flooded with incoming traffic. Different sections of the hierarchical structure can be traversed based on whether a trigger is activated or not. Specifically, nodes in the hierarchical structure can be trigger points/decision points to determine whether a trigger has occurred. In turn, a specific section of the hierarchical tree that is connected to the node can be traversed based on whether the trigger has occurred. For example branch A connected to a node can be traversed if the trigger occurs and branch B connected to the node can be traversed in the trigger does not occur.

A playbook can comprise an automated action. An automated action can comprise an action that is capable of being performed/is performed by a system other than a human in executing a playbook. Further, a playbook can comprise a manual action. A manual action can comprise an action that is capable of being performed/is performed by a human in executing a playbook. Automated and manual actions can be trigger-specific actions that form part of a hierarchical structure of a playbook.

While the technology is described in this disclosure with respect to incidents, in various embodiments, the technology can be practiced with respect to other applicable occurrences, such as changes and alerts. For example, the technology can be applied to repetitive workflow occurrences. Further, technology described herein can be practiced in other applicable domains outside of incident resolution, such as marketing operations, financial operations, and legal operations.

Incident data stored in the incidents datastore 204 can comprise applicable data describing an incident and an attempt to resolve the incident. Specifically, incident data stored in the incidents datastore 204 can comprise data describing the circumstances of an incident and other applicable data for characterizing the incident. For example, incident data can describe the occurrences that formed the incident. Further, incident data stored in the incidents datastore 204 can comprise data indicating whether or not a resolution was achieved for the incident and data describing characteristics of the result, including both a resolution result and a non-resolution result. Additionally, incident data stored in the incidents datastore 204 can comprise data describing steps that were taken in an attempt to achieve a resolution for the incident, otherwise referred to as resolution steps.

The incident clustering system 202 functions to cluster incidents from incident data stored in the incidents datastore 204. In various embodiments, the incident clustering system 202 can function to cluster only incidents that have resolutions while refraining from including or otherwise clustering incidents that lack a resolution. This can help in ensuring creation of a playbook comprising steps for actually achieving a resolution.

The incident clustering system 202 can use an applicable technique for clustering incidents together. Specifically, and as will be discussed in greater detail later, the incident clustering system 202 can use embeddings to cluster incidents together. The incident clustering system 202 can cluster incidents together based on a similarity criterion. A similarity criterion can comprise an applicable measure or basis for grouping together incidents for purposes of developing a playbook, such as text or word similarity. Specifically, a similarity criterion can be based on a text description of characteristics of incidents, such as incident types, entities involved or associated with the incidents, and other applicable characteristics or descriptions of the incidents. For example, a similarity criterion can define clustering incidents that are related to fixing issues with a specific type of software. A similarity criterion can be defined relative to a threshold, e.g. a quantifiable threshold. For example, if incidents are similar, according to a similarity criterion, within a threshold amount, then the incident cluster system 202 can cluster the incidents together.

Incidents can be filtered at various points in the example architecture shown in FIG. 2. Specifically, incidents can be filtered before they are clustered. The incidents can be filtered through an applicable filtering criterion. Specifically, incidents can be filtered to include only problems and example incidents that are applicable for automation through a playbook. An applicable system can apply a filtering criterion for determining whether to filter incidents. For example, the LLM 210 can filter the incidents to include only those incidents that are suitable for automation through a playbook.

The example architecture shown in FIG. 2 comprises an embedding model 206. The embedding model 206 can comprise an applicable model for mapping text data into a vector space. Specifically, the embedding model 206 can be part of an applicable generative artificial intelligence (AI) model, such as the LLM 210 included in the architecture 200 shown in FIG. 2. Alternatively, embedding model 206 can be separate from the LLM 2210 in the architecture 200 shown in FIG. 2.

The incident clustering system 202 can use the embedding model 206 to cluster incidents together based on incident data stored in the incidents datastore 204. Specifically, the incident clustering system 202 can use the embedding model 206 to determine the similarity between text content describing incidents and stored as incident data in the incident datastore 204. More specifically, the embedding model 206 can be used to determine the similarity between text descriptions of incidents, and the similarity can be compared by the incident clustering system 202 to a similarity criterion to determine whether to cluster the incidents together. For example, the embedding model 206 can be applied to determine that descriptions of incidents include similar text related to resolving a Zoom® incident. As follows, the incident clustering system 202 can cluster the incidents together based on the similarity of the text descriptions of the incidents. In another example, the embedding model 206 can be applied to determine that descriptions of resolution steps in incidents are similar. In turn, the incident clustering system 202 can cluster the incidents together based on the similarity of the descriptions of the resolution steps.

The incident clustering system 202 can prioritize, order, or otherwise rank, the clustered incidents. Specifically, the incident clustering system 202 can prioritize the clustered incidents based on a prioritization criterion. A prioritization criterion for prioritizing clustered incidents can be an applicable measure or basis for prioritizing incidents. For example, a prioritization criterion can be defined based on a degree of similarity, e.g. semantic similarity between descriptions of incidents. In turn, the incident clustering system 202 can rank the incidents that are most similar higher than incidents that are less similar from a text description perspective. Further, a prioritization criterion can be defined based on a size of the clustered group of incidents. For example, the incident clustering system 202 can filter out, or otherwise de-prioritize, clustered instances if the number of clustered instances is lower than a threshold number of instances.

The architecture 200 shown in FIG. 2 also comprises an incident summary system 208. The incident summary system 208 functions to facilitate generation of a summary of the incidents clustered together by the incident clustering system 202. The incident summary system 208 can use an applicable system and technique to generate a summary of the incident. Specifically, the incident summary system 208 can utilize the LLM 210 to generate a summary of the clustered incidents. A summary of a clustered incident, as generated through the incident summary system 208, can comprise applicable information describing an incident and a resolution to the incident. For example, an incident summary can include a description of resolution steps taken to resolve the incident, an order in which the resolution steps were taken, and a summary of the incident itself.

The incident summary system 208 can select specific incidents of the clustered incidents to summarize. In particular, the incident summary system 208 can sample the clustered instances while refraining from generating a summary for all clustered instances. This can conserve computational resources. The incident summary system 208 can sample the clustered incidents according to an applicable technique. For example, the incident summary system 208 can sample the clustered incidents based on a ranked priority of the clustered incidents. In another example, the incident summary system 208 can sample the clustered incidents based on a random or pseudo-random selection technique. In yet another example, the incident summary system 208 can sample the clustered incidents based on whether the clustered incidents are re-clustered incidents. Specifically, if incidents have been clustered through re-clustering, as will be discussed in greater detail later, then the incident summary system 208 can select the re-clustered incidents. In another example, the incident summary system 208 can use an applicable diverse sampling technique to select the incidents.

The following is an example of a prompt that can be created by the incident summary system 208 for generating a summary of an incident. Specifically, the incident summary system 208 can provide corresponding incident data stored in the incident datastore 204 and the following prompt to the LLM 210 for generating a summary of an incident. More specifically, the content and details referenced in the prompt can include corresponding incident data for the incident that is stored in the incidents datastore 204.

Assume you are an expert IT technical support analyst tasked with automating incident resolutions. Using the details given below, create a list of steps to resolve any future incidents that might face a similar issue. Follow the instructions below.
1. The response should contain only the resolution steps and nothing else.
2. Each step should be clear and actionable.
3. Steps should be genericized by excluding incident-specific data.
4. If there are logical steps, do not compress them into one step.
5. Omit the incident closing step.
6. The content will start after this instruction.

The incident summary system 208 can function to prioritize, order, or otherwise rank the summaries of the clustered incidents. Specifically, the incident summary system 208 can prioritize the summaries of the clustered incidents according to a prioritization criterion. A prioritization criterion for prioritizing summaries of clustered incidents can be an applicable measure or basis for prioritizing the incident summaries. Specifically, a prioritization criterion can be defined based on a time in which the incidents occur. For example, the incident summary system 208 can filter out summaries of incidents that all occur within a single hour of each other. Further, a prioritization criterion can be defined based on a size of the clustered group of incidents. For example, the incident summary system 208 can filter out summaries of clustered instances if the number of clustered instances is lower than a threshold number of instances.

The architecture 200 comprises an automatic playbook generator 212. The automatic playbook generator 212 functions to generate a playbook for resolving an incident based on the summaries of clustered incidents generated by the incident summary system 208. The automatic playbook generator 212 can use an applicable AI/ML technique to generate a playbook based on summaries of clustered incidents. Specifically, the automatic playbook generator 212 can use the LLM 210 to generate a playbook based on summaries of clustered incidents in an automated manner.

In using the LLM 210 to generate the playbook based on summaries of clustered incidents, the automatic playbook generator 212 can generate a prompt that comprises summaries of the clustered incidents. Further the prompt can specify specific rules for generating the playbook in an automated manner from the summaries of the clustered incidents. Rules included in the prompt can comprise applicable rules that either or both a human and a LLM can follow in generating a playbook for resolving an incident. Specifically, the rules can detail logical steps used by a human in analyzing past instances to generate a playbook. In turn, the automatic playbook generator 212 can provide the prompt to the LLM 210 for generating the playbook. Examples of rules are represented in the following example prompt which can be used by the LLM 210 to generate the playbook based on summaries of clustered incidents.

You are an IT automation expert tasked with consolidating resolutions from a group of similar incidents to form a unified playbook skeleton. Follow these guidelines:
1. Prioritize Common Actions: Actions that are common to most incidents and are more likely to resolve the problem should be listed earlier.
2. Simple and Effective Actions: If no common actions are identified, prioritize simple, easy-to-execute actions (low-hanging fruit).
3. Parallel Activities: Consider parallel activities; not all steps must be performed in sequence.
4. Detail Levels: Use no more than two levels of detail. For example, a step like “verify the problem” can include sub-steps such as “open the page from your browser” and “impersonate the user and try to recreate the problem.”
5. Iterative Batches: Due to input token-length limitations, incidents and resolution summaries will be provided in batches. Each step should include statistical information on its relevance to help reconcile with subsequent batches (how many examples was it relevant for so far).
6. IT Domain Focus: Keep all steps and actions within the IT domain. Ignore irrelevant, disputed, unclear, or nonsensical information. Prioritize correctness over completeness.
7. Logical Additions: You may add logical steps that make sense. For example, if verification of the problem is not covered but is logically necessary, include it.
8. Standard Steps: The playbook should cover these steps:
Identify and Verify
Categorize and Prioritize
Gather Information
Determine the Cause
Implement Solution
Test Solution
Communicate the Resolution

Current Playbook Skeleton:
<summary>
Next Batch:
<input>
Additionally, in using the LLM 210 to generate the playbook based on summaries of clustered incidents, the automatic playbook generator 212 can iteratively prompt the LLM 210 with the resolution steps across incidents to infer the playbook. Specifically, the automatic playbook generator 212 can create a hierarchy of resolution steps by inferring resolution steps from incident summaries and reasoning a logical order to apply the resolution steps in resolving an incident. As the LLM 210 is iteratively prompted with more incident summaries it can continue to infer resolution steps that can be inserted into the hierarchy and proper logical locations for the resolution steps in the hierarchy. Accordingly, the LLM 210 can create an order of actions along with trigger points, e.g. decision points, that correspond to different sections of the hierarchy.

The LLM 210 can generate the playbook without a template. Alternatively, the LLM 210 can generate the playbook from a template. Specifically, a currently existing playbook can serve as a template for the LLM 210 in generating the playbook. The existing playbook that serves as a template for the LLM 210 can be specific to an entity or generic across various entities.

The LLM 210 can be fed the summaries for generating playbook in a recursive approach. Specifically, the LLM 210 can be recursively fed batches of incidents over time to grow a playbook. This is in contrast with a direct approach, where the LLM 210 is fed all of the summaries, e.g. at the same time, which can overwhelm the LLM 210.

The LLM 210 can maintain statistics and other metadata about the steps of created playbooks and application of the steps in applying the playbooks. For example, the LLM 210 can maintain records indicating which steps are continuously used in resolving incidents through application of a playbook. As follows, the LLM 210 can updated the playbook based on the maintained records and statistics. For example, the LLM 210 can reorder and prioritize steps in the playbook based on whether the steps are continuously used or not used at all.

The playbook datastore 214 stores playbook data of a playbook generated by the automatic playbook generator 212. Playbook data of a playbook can comprise applicable data for implementing the playbook, e.g. by a human. Specifically, playbook data can include, in a natural language, a hierarchical structure of trigger-specific action and trigger points at nodes, for guiding traversal of the hierarchical structure. Further, playbook data can comprise a summary of the incident and type of incident that can be resolved through implementation of the playbook. Playbook data can also comprise data describing either or both the clustered events and summaries of clustered events that were used in generating the playbook.

The incident clustering system 202 can function to re-cluster incidents for modifying and updating playbooks. Specifically, the incident clustering system 202 can access playbook data for a playbook stored in the playbook datastore 214. As follows, the incident clustering system 202 can re-cluster the incidents used in creating the playbook with different incidents. The different incidents can comprise incidents that have occurred since the playbook was created. In turn, the re-clustered incidents can be used in updating the playbook or generating a new playbook through the techniques described herein. Specifically, incident summaries of the newly clustered incidents can be generated and used in automatically generating a new or updated playbook through the LLM 210. In updating the playbook, resolution steps can be added or removed to the playbook. Further, the order of the resolution steps, e.g. in relation to trigger points, can be modified as part of updating the playbook.

FIG. 3 illustrates a flowchart 300 of an example method of clustering incidents and generating a playbook for resolving an incident through an LLM based on summaries of the clustered incidents, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, incidents having resolutions are clustered together through an embedding model based on a similarity criterion. Using incidents that have a resolution, as opposed to incidents that lack a resolution in forming a playbook, is technically advantageous as it can ensure a playbook is created that ultimately has a resolution for an incident. Using an embedding model to cluster incidents together is technically advantageous as discrepancies in incident records across different entities can be accounted for in generating a playbook. In turn, accounting for discrepancies across entities in incident records is advantageous as data diversity for creating a playbook is increased, thereby leading to the creation of a playbook that is more accurate and efficient in resolving a specific incident. Further, using an embedding model is technical advantageous as it can eliminate the need for a human to check large volumes of closed incident records, including resolution notes within the incident records.

At module 304, a summary of each of the incidents is generated through an LLM. Specifically, the LLM can be prompted to generate a summary of resolution steps in each of the incidents. Further, the LLM can be prompted to generate an overall summary of each of the incidents. For example, the LLM can be prompted to generate a summary of the incident, including issues that disrupt normal operation to cause the incident. Generating a summary of the clustered incidents through an LLM, e.g. in an automated manner, is technically advantageous as it can save human resources. Further, using an LLM to generate a summary of the clustered incidents can reduce the chances of a human mischaracterizing the clustered incidents, potentially leading to creation of an inaccurate or ineffective playbook based on the incidents. Additionally, using an LLM to generate a summary can lead to a uniform summary of the incidents when the incidents occur across different entities using different nomenclature. In turn, this uniform summary of the clustered incidents can further facilitate the creation of a playbook from incidents that occur across different entities.

At module 306, a playbook for resolving an incident through the LLM is inferred based on the summaries of the incidents. Specifically, the LLM can be prompted with the different resolution steps indicated in the summaries of the clustered incidents to infer a playbook for resolving an incident, e.g. a specific incident or specific type of incident related to the clustered instances. Using an LLM to infer a playbook from a summary of clustered instances is technically advantageous as the playbook can be generated in an automated or semi-automated manner. In turn, inferring a playbook through an LLM can lead to more accurate and effective playbook generation, e.g. by eliminating or reducing the risk of human error in playbook generation.

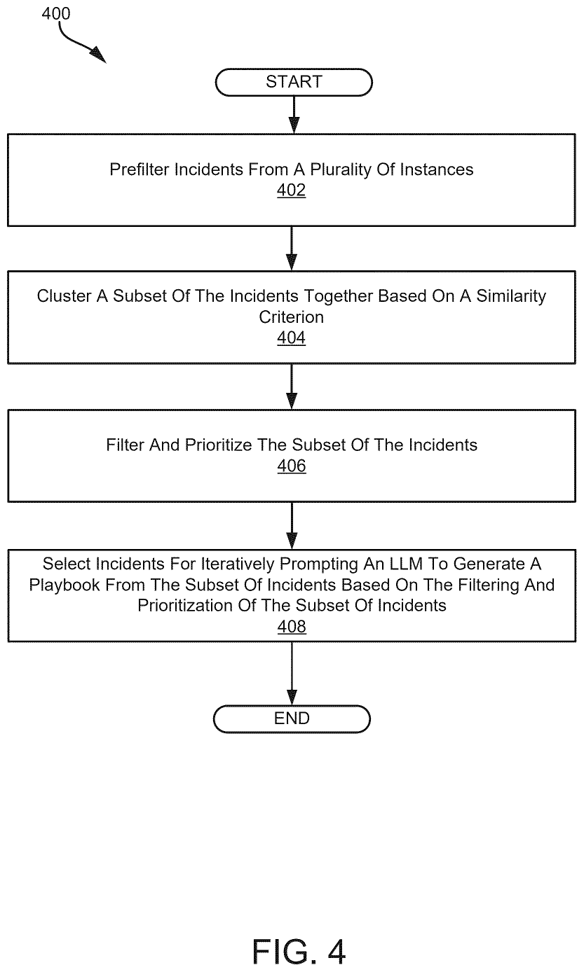

FIG. 4 illustrates a flowchart 400 of an example method of prefiltering incidents to cluster incidents and filtering, prioritizing, and selecting the clustered incidents in generating a playbook for resolving an incident, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, incidents are prefiltered from a plurality of instances. The prefiltering of incidents at module 402 can be performed before the incidents are summarized and potentially used in generating a playbook. Incidents that do not have resolutions can be prefiltered. Further, incidents that do not have work notes or enough applicable description for summarizing the incidents can be prefiltered. Prefiltering incidents before the incidents are summarized and potentially used in generating a playbook is technically advantageous as it can conserve computational resources that would be wasted in processing the prefiltered incidents, e.g. during incident summarization.

At module 404, a subset of the prefiltered incidents are clustered together based on a similarity criterion. Specifically, a subset of the prefiltered incidents can be clustered together through an embedding model based on the similarity criterion. The prefiltered incidents can be clustered together agnostic as to an entity associated with the entity records. Specifically, the prefiltered incidents can be clustered together across different entities that were affected by and/or maintain incident records for the incidents irrespective of the different entities.

At module 406, the subset of the incidents are filtered and prioritized. The subset of the incidents can be filtered and prioritized according to a specific criterion, e.g. such as a prioritization criterion. The subset of the incidents can be filtered and prioritized, at module 406, after the incidents are clustered and before at least a portion of the subset of incidents are summarized. Alternatively, the subset of incidents can be filtered and prioritized, at module 406, after the incidents are clustered and summarized. Further, the subset of the incidents can be filtered and prioritized at module 406 in two different stages. Specifically, the subset of the incidents can be filtered and prioritized before incident summarization. As follows, all or a portion of the subset of the incidents can be selected and summarized based on the filtering and prioritization. Then, the resultant summarized incidents can be filtered and prioritized again. As follows, all or a portion of the summarized incidents can be selected and used in inferring a playbook based on the filtering and prioritization.

As follows, incidents for iteratively prompting an LLM to generate a playbook are selected, at module 408, from the subset of incidents based on the filtering and prioritization of the subset of incidents. Specifically, incidents and/or incident summaries that remain after filtering can be selected. Further, incident and/or incident summaries that are prioritized more greatly can be selected.

The incidents and/or incident summaries can be filtered, prioritized, and then subsequently selected according to a suitability of the incidents and/or incident summaries for generating a playbook. Specifically, incidents and/or incident summaries can be filtered and prioritized to ensure that a suitable number of incident summaries are available for generating a playbook. Filtering, prioritizing, and selecting incidents and/or incident summaries to ensure that a suitable number of incident summaries are available is technically advantageous as it can ensure that an accurate playbook can be generated. Specifically, an accurate playbook can be generated while conserving computational resources that would be expended in summarizing and using incidents that are unsuitable for generating the playbook. Further, the incidents and/or incident summaries can be filtered, prioritized, and selected based on whether the incidents describe situations that are repeatable. Filtering, prioritizing, and selecting incidents and/or incident summaries to ensure that playbooks are generated from incidents that are repeatable is technically advantageous in that it can help to ensure that an inferred playbook can apply to future incidents.

An applicable ML model, such as an LLM, can be used in prioritizing, filtering, and selecting the incidents and incident summaries according to the technology described herein, e.g. with reference to the architecture 200 shown in FIG. 2. Specifically, the criteria described herein can be defined and implemented through an LLM. In particular, an LLM can be prompted about whether an incident and/or incident summary is a suitable candidate for inferring a playbook. As follows, the incident and/or incident summary can be filtered, prioritized, and selected based on whether the LLM determines it is a suitable candidate. Using an LLM to determine the suitability of an incident/incident summary as a candidate for inferring a playbook is technically advantageous as it increases the number of incidents/incident summaries that can be reviewed, e.g. as opposed to if a human was performing the review. In turn, this can increase data diversity, potentially leading to the creation of a playbook that is more accurate and efficient in resolving an incident.

An ML model can be used to determine the suitability of resolution steps for inferring a playbook as part of determining whether an incident/incident summary is a suitable candidate for inferring a playbook. Specifically, an ML model can score an incident/incident summary based on clarity and structure. In particular, an ML model can score an incident/incident summary based on whether corresponding resolution notes, e.g. as part of incident data, have a clear sequence of actions and decision points, whether the resolution steps can be understood by operators with varying experience levels, and whether the resolution notes conclude with a clear and definitive resolution. Further, an ML model can score an incident/incident summary based on generalizability and applicability. Specifically, an ML model can score an incident/incident summary based on whether actions and decisions are generalizable for application to future incidents and whether an incident has a clear category or a title that captures some or nearly all related incidents. Additionally, an ML model can score an incident/incident summary based on completeness and coverage. Specifically, an ML model can score an incident/incident summary based on whether a flow includes any unexplored or uncovered scenarios, whether the flow covers essential steps in incident resolution, and whether the resolution notes reveal any undocumented activities or logical gaps. Examples of essential steps in incident resolution include issue identification, information gathering, analysis, resolution implementation, and verification.

The following is an example prompt that can be provided to an LLM to score an incident/incident summary.

Consider each of the following aspects, and for each aspect select a score based on the definitions provided for that aspect:

### Aspect 1—Clarity and Structure

Do the resolution notes provide a clear sequence of actions and decision points?

Are the steps simple enough for less experienced operators to follow?

Do the resolution notes conclude with a clear and definitive resolution?

### Scoring:

The actions, decisions, and resolutions are unclear, confusing, or overly complex, making them difficult for less experienced operators to follow.

The actions and decisions are somewhat clear but may need further clarification or simplification. The resolution is generally clear but may lack full definitiveness.

The actions, decisions, and resolutions are exceptionally clear and easy to follow, even for less experienced operators.

### Aspect 2—Generalizability and Applicability

Are the actions and decisions generalizable, making them applicable to similar future incidents?

Is there a clear category or title that effectively captures all, or nearly all, related incidents?

### Scoring:

The actions and decisions are highly specific and unlikely to apply to future incidents. The category or title poorly captures related incidents.

The actions and decisions are somewhat generalizable but may require adjustments for future incidents. The category or title captures most related incidents but may miss some edge cases.

The actions and decisions are broadly generalizable, with a category or title that effectively captures all related incidents.

### Aspect 3—Completeness and Coverage

Does the flow include any unexplored or uncovered scenarios?

Does the flow cover essential steps, such as issue identification, information gathering, analysis, resolution implementation, and verification?

Do the resolution notes reveal any undocumented activities or logical gaps?

### Scoring:

The flow has significant gaps, missing important scenarios or steps, and includes undocumented activities or logical gaps, leading to inconsistency and confusion.

The flow is mostly complete but may overlook some scenarios or steps and contain minor undocumented activities or logical gaps.

The flow is comprehensive, covering all relevant scenarios and steps thoroughly, with no undocumented activities or logical gaps.

Example output (output only this, without any accompanying text):
′″

### Aspect, Score

1, 2
2, 3
3, 1
′″

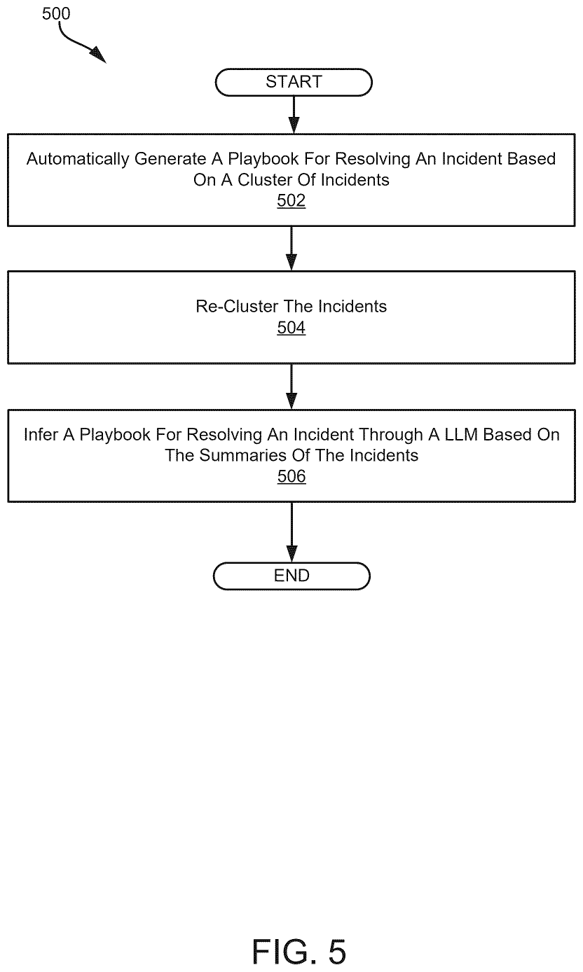

FIG. 5 illustrates a flowchart 500 of an example method of re-clustering incidents and generating a playbook based on the re-clustered incidents, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, a playbook for resolving an incident is automatically generated based on a cluster of incidents. The playbook can be generated according to the techniques described herein. Specifically, incidents can be clustered through an embedding model. The clustered incidents can then be summarized and the summaries can be used to automatically infer a playbook.

At module 504, the incidents are re-clustered. The incidents can be re-clustered in response to an applicable event. Specifically, the incidents can be re-clustered in response to the occurrence of new incidents that can be used in generating a new or updated playbook. Further, the incidents can be re-clustered in response to a modification to software or an asset that is the subject of an event. For example, the incidents can be re-clustered in response to an updated of software that is the subject of or otherwise associated with the playbook.

The incidents can be re-clustered based on an evaluation of the playbook. Specifically, the inferred playbook can be evaluated by an applicable source to determine its suitability for resolving an incident. More specifically, an LLM can be prompted to determine whether the playbook is still suitable for resolving an incident. If it is determined that the playbook is not suitable for resolving an incident, then the incidents can be re-clustered.

At module 506, a playbook for resolving an incident is inferred through an LLM based on the summaries of the incidents. As follows, a playbook for resolving an incident can be inferred through an LLM based on summaries of the re-clustered incidents. The playbook can be a new playbook. Further, the playbook can be an updated playbook from the playbook that is generated at module 502. Applying a re-clustering loop, including re-clustering incidents and generating a playbook based on summaries of the re-clustered incidents, can reduce problems associated with drift in playbooks. Further, applying a re-clustering loop can account for updates to software that is the subject of the playbook. For example, if a new version of software introduces new features leading to the creation of new incidents, then the playbook associated with the software can be updated based on the new incidents to account for the new software version.

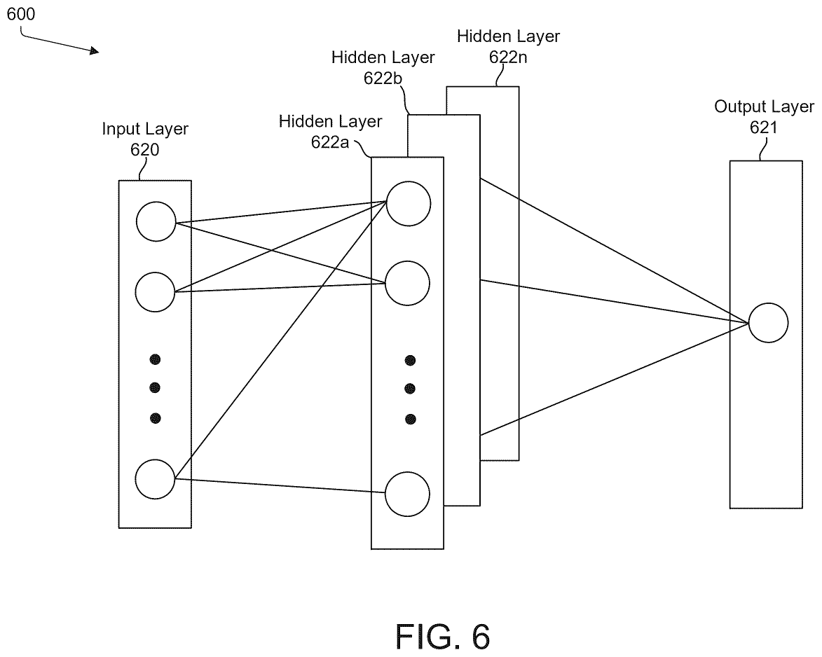

In FIG. 6, the disclosure now turns to a further discussion of models that can be used to implement the technology described herein. FIG. 6 is an example of a deep learning neural network 600 that can be used to implement all or a portion of the systems and techniques described herein, according to some examples of the present disclosure. An input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2 (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

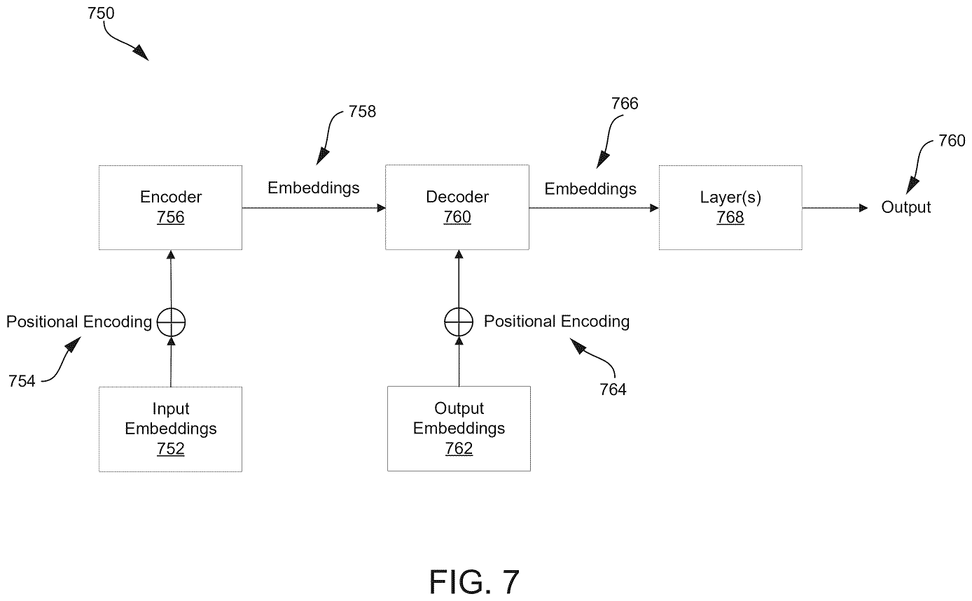

FIG. 7 is a diagram illustrating an example architecture of an example transformer model 750, according to some examples of the present disclosure. The transformer model 750 can be used to implement an LLM that can be used to implement the technology described herein. As shown, the transformer model 750 can include input embeddings 752 used as inputs to the transformer model 750. The input embeddings 752 can include input values representing words and/or sentences, such as numbers or vectors representing words and/or sentences.

In some cases, the input embeddings 752 can function like a dictionary that helps the transformer model 750 understand the meaning of words by placing them in an embedding space where similar words are located near each other. In some examples, the input interface 134 can be trained and/or configured to create the input embeddings 752 so that similar vectors represent words with similar meanings. In some examples, the transformer model 750 can additionally or alternatively learn to create and/or process the input embeddings 752 during training.

The transformer model 750 can use positional encoding 754 to encode the position of each word in an input sequence from the input embeddings 752 as values such as a set of numbers, a vector, etc. The values generated by the positional encoding 754 can be fed into the transformer model 750 along with the input embeddings 752. By incorporating the positional encoding 754 into the transformer model 750, the transformer model 750 can more effectively understand the order of words in a sentence and generate grammatically correct and semantically meaningful output.

The transformer model 750 can include an encoder(s) 756 used to process the positionally encoded input embeddings 752 and generate embeddings 758. The encoder(s) 756 can be part of the transformer model 750 that processes input text and generates hidden states that capture the meaning and context of the text. For example, the encoder(s) 756 can include a feed-forward neural network that is part of the transformer model 750. In some examples, the encoder(s) 756 can implement multiple encoder layers. In some cases, the encoder(s) 756 can first tokenize the input text into a sequence of tokens, such as individual words or subwords. The encoder(s) 756 can then apply one or more self-attention layers, which can generate hidden states that represent the input text at different levels of abstraction. In this way, the encoder(s) 756 can generate the embeddings 758 (e.g., a vector, a set of values, etc.) representing the semantics and position of words in one or more sentences.

The transformer model 750 can include output embeddings 762, which can include values representing words and/or sentences, such as numbers or vectors representing words and/or sentences. The output embeddings 762 can be similar to the input embeddings 752 and can also be processed by positional encoding 764 to encode the position of each word in a sequence from the output embeddings 762 as values such as a set of numbers, a vector, etc., which helps the transformer model 750 understand the order of words in a sentence. The output embeddings 762 can be used during a training phase of the transformer model 750 and can be used during an inference phase. During training, a loss function can be computed based on the output embeddings 762 and used to update the model parameters to improve the accuracy of the transformer model 750. During an inference phase, the output embeddings 762 can be used to generate the output text by mapping the predicted probabilities determined by the transformer model 750 for each token to the corresponding token in the vocabulary.

The positionally encoded input embeddings 752 (e.g., the embeddings 758) and the positionally encoded output embeddings 762 can be fed to a decoder(s) 760 used to generate the output sequence based on the encoded input sequence. During training, the decoder(s) 760 can learn how to guess the next word of a sequence by looking at the words before it. In some examples, the decoder(s) 760 can generate natural language text based on the input sequence and any learned context.

The decoder(s) 760 can generate embeddings 766 and feed the embeddings 766 to one or more network layers 768. In some examples, the one or more network layers 768 can include a linear layer and a softmax function. The linear layer can map the embeddings 766 generated by the decoder(s) 760 to a higher-dimensional space, which can transform the embeddings 766 into the original input space. The softmax function can then be applied to generate a probability distribution for each output token in the vocabulary, which can result in an output 770. In some examples, the output 770 can include output tokens with probabilities.

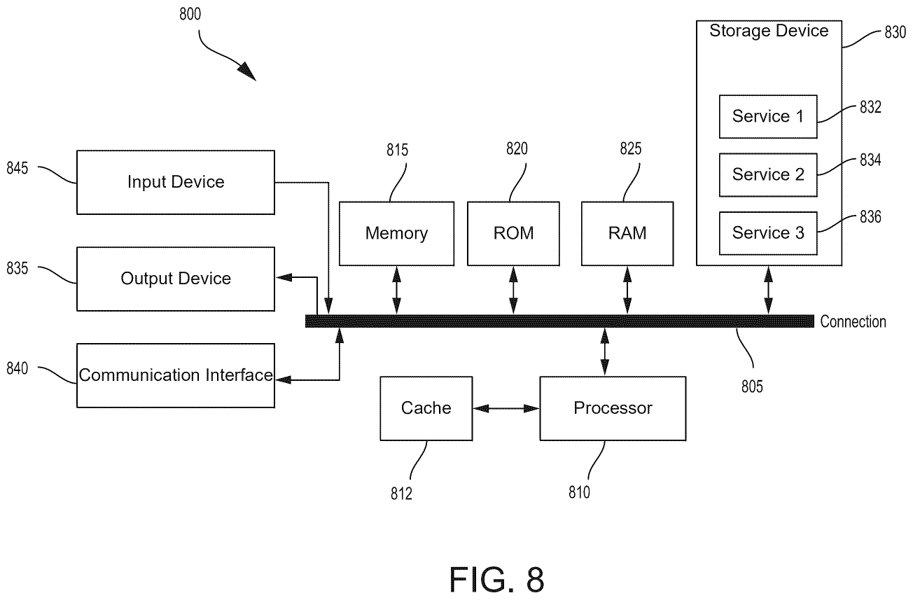

FIG. 8 illustrates an example processor-based system with which some embodiments of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:
Embodiment 1. A computer-implemented method comprising: clustering incidents having resolutions together through an embedding model based on a similarity criterion; generating a summary of each of the incidents through a large language model (LLM); and inferring a playbook for resolving an incident through the LLM based on the summaries of the incidents.

Embodiment 2. The computer-implemented method of Embodiment 1, further comprising: generating a prompt comprising the summaries of the incidents and rules for generating the playbook; and providing the prompt to the LLM, wherein the LLM is configured to generate the playbook based on the prompt.

Embodiment 3. The computer-implemented method of either of Embodiments 1 or 2, wherein the summaries of the incidents comprise resolution steps associated with achieving the resolutions in the incidents, the method further comprising iteratively prompting the LLM with the resolution steps across one or more of the incidents to infer the playbook.

Embodiment 4. The computer-implemented method of any of Embodiments 1 through 3, wherein the playbook is unique to an entity and inferred based on an existing playbook for the entity.

Embodiment 5. The computer-implemented method of any of Embodiments 1 through 3, wherein the playbook is entity agnostic and specific to the incidents from which it is created.

Embodiment 6. The computer-implemented method of any of Embodiments 1 through 5, wherein the playbook comprises trigger-specific actions and corresponding triggers arranged in a hierarchical structure for resolving an incident.

Embodiment 7. The computer-implemented method of any of Embodiments 1 through 6, wherein the playbook comprises an automated action.

Embodiment 8. The computer-implemented method of any of Embodiments 1 through 7, wherein the playbook comprises a manual action.

Embodiment 9. The computer-implemented method of any of Embodiments 1 through 8, further comprising prefiltering the incidents from a plurality of incidents before clustering the incidents.

Embodiment 10. The computer-implemented method of any of Embodiments 1 through 9, further comprising: filtering a subset of the incidents after the incidents are clustered based on a specific criterion; and inferring the playbook for resolving the incident through the LLM based on summaries of the subset of incidents.

Embodiment 11. The computer-implemented method of any of Embodiments 1 through 10, further comprising: prioritizing the incidents after the incidents are clustered into a prioritized list of the incidents based on a prioritization criterion; selecting a subset of the incidents from the prioritized list based on an order of the subset of the incidents in the prioritized list; and inferring the playbook for resolving the incident through the LLM based on summaries of the subset of incidents.

Embodiment 12. The computer-implemented method of any of Embodiments 1 through 11, re-clustering the incidents to create a modified group of incidents; and generating the playbook through the LLM based on summaries of incidents in the modified group of incidents.

Embodiment 13. A system comprising: one or more processors; and at least one computer-readable storage medium having stored therein instructions which, when executed by the one or more processors, cause the one or more processors to: cluster incidents having resolutions together through an embedding model based on a similarity criterion; generate a summary of each of the incidents through a large language model (LLM); and infer a playbook for resolving an incident through the LLM based on the summaries of the incidents.

Embodiment 14. The system of Embodiment 13, wherein the instructions further cause the one or more processors to: generate a prompt comprising the summaries of the incidents and rules for generating the playbook; and provide the prompt to the LLM, wherein the LLM is configured to generate the playbook based on the prompt.

Embodiment 15. The system of either of Embodiments 13 or 14, wherein the summaries of the incidents comprise resolution steps associated with achieving the resolutions in the incidents and the instructions further cause the one or more processors to iteratively prompt the LLM with the resolution steps across one or more of the incidents to infer the playbook.

Embodiment 16. The system of any of Embodiments 13 through 15, wherein the playbook comprises trigger-specific actions and corresponding triggers arranged in a hierarchical structure for resolving an incident.

Embodiment 17. The system of any of Embodiments 13 through 16, wherein the instructions further cause the one or more processors to: filter a subset of the incidents after the incidents are clustered based on a specific criterion; and infer the playbook for resolving the incident through the LLM based on summaries of the subset of incidents.

Embodiment 18. The system of any of Embodiments 13 through 17, wherein the instructions further cause the one or more processors to: prioritize the incidents after the incidents are clustered into a prioritized list of the incidents based on a prioritization criterion; select a subset of the incidents from the prioritized list based on an order of the subset of the incidents in the prioritized list; and infer the playbook for resolving the incident through the LLM based on summaries of the subset of incidents.

Embodiment 19. The system of any of Embodiments 13 through 18, wherein the instructions further cause the one or more processors to: re-cluster the incidents to create a modified group of incidents; and generate the playbook through the LLM based on summaries of incidents in the modified group of incidents.

Embodiment 20. A non-transitory computer-readable storage medium storing instructions for causing one or more processors to: cluster incidents having resolutions together through an embedding model based on a similarity criterion; generate a summary of each of the incidents through a large language model (LLM); and infer a playbook for resolving an incident through the LLM based on the summaries of the incidents.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
clustering incidents having resolutions together through an embedding model based on a similarity criterion;
generating a summary of each of the incidents through a large language model (LLM); and
inferring a playbook for resolving an incident through the LLM based on the summaries of the incidents.

2. The computer-implemented method of claim 1, further comprising:
generating a prompt comprising the summaries of the incidents and rules for generating the playbook; and
providing the prompt to the LLM, wherein the LLM is configured to generate the playbook based on the prompt.

3. The computer-implemented method of claim 2, wherein the summaries of the incidents comprise resolution steps associated with achieving the resolutions in the incidents, the method further comprising iteratively prompting the LLM with the resolution steps across one or more of the incidents to infer the playbook.

4. The computer-implemented method of claim 1, wherein the playbook is unique to an entity and inferred based on an existing playbook for the entity.

5. The computer-implemented method of claim 1, wherein the playbook is entity agnostic and specific to the incidents from which it is created.

6. The computer-implemented method of claim 1, wherein the playbook comprises trigger-specific actions and corresponding triggers arranged in a hierarchical structure for resolving an incident.

7. The computer-implemented method of claim 1, wherein the playbook comprises an automated action.

8. The computer-implemented method of claim 1, wherein the playbook comprises a manual action.

9. The computer-implemented method of claim 1, further comprising prefiltering the incidents from a plurality of incidents before clustering the incidents.

10. The computer-implemented method of claim 1, further comprising:
filtering a subset of the incidents after the incidents are clustered based on a specific criterion; and
inferring the playbook for resolving the incident through the LLM based on summaries of the subset of incidents.

11. The computer-implemented method of claim 1, further comprising:
prioritizing the incidents after the incidents are clustered into a prioritized list of the incidents based on a prioritization criterion;
selecting a subset of the incidents from the prioritized list based on an order of the subset of the incidents in the prioritized list; and
inferring the playbook for resolving the incident through the LLM based on summaries of the subset of incidents.

12. The computer-implemented method of claim 1, further comprising:
re-clustering the incidents to create a modified group of incidents; and
generating the playbook through the LLM based on summaries of incidents in the modified group of incidents.

13. A system comprising:
one or more processors; and
at least one computer-readable storage medium having stored therein instructions which, when executed by the one or more processors, cause the one or more processors to:
cluster incidents having resolutions together through an embedding model based on a similarity criterion;
generate a summary of each of the incidents through a large language model (LLM); and
infer a playbook for resolving an incident through the LLM based on the summaries of the incidents.

14. The system of claim 13, wherein the instructions further cause the one or more processors to:
generate a prompt comprising the summaries of the incidents and rules for generating the playbook; and
provide the prompt to the LLM, wherein the LLM is configured to generate the playbook based on the prompt.

15. The system of claim 14, wherein the summaries of the incidents comprise resolution steps associated with achieving the resolutions in the incidents and the instructions further cause the one or more processors to iteratively prompt the LLM with the resolution steps across one or more of the incidents to infer the playbook.

16. The system of claim 15, wherein the playbook comprises trigger-specific actions and corresponding triggers arranged in a hierarchical structure for resolving an incident.

17. The system of claim 13, wherein the instructions further cause the one or more processors to:
filter a subset of the incidents after the incidents are clustered based on a specific criterion; and
infer the playbook for resolving the incident through the LLM based on summaries of the subset of incidents.

18. The system of claim 13, wherein the instructions further cause the one or more processors to:
prioritize the incidents after the incidents are clustered into a prioritized list of the incidents based on a prioritization criterion;
select a subset of the incidents from the prioritized list based on an order of the subset of the incidents in the prioritized list; and
infer the playbook for resolving the incident through the LLM based on summaries of the subset of incidents.

19. The system of claim 13, wherein the instructions further cause the one or more processors to:
re-cluster the incidents to create a modified group of incidents; and
generate the playbook through the LLM based on summaries of incidents in the modified group of incidents.

20. A non-transitory computer-readable storage medium storing instructions for causing one or more processors to:
cluster incidents having resolutions together through an embedding model based on a similarity criterion;
generate a summary of each of the incidents through a large language model (LLM); and
infer a playbook for resolving an incident through the LLM based on the summaries of the incidents.
